(19) United States
(12) Patent Application Publication
(10) Pub. No.: US 2007/0185990 A1
(43) Pub. Date: Aug. 9, 2007

(54) Computer-readable recording medium with recorded performance analyzing program, performance analyzing method, and performance analyzing apparatus

(75) Inventors: Miyuki Ono, Kawasaki (JP); Shuji Yamamura, Kawasaki (JP); Akira Hirai, Kawasaki (JP); Kazuhiro Matsumoto, Kawasaki (JP); Kouichi Kumon, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/453,215

(22) Filed: Jun. 15, 2006

(30) Foreign Application Priority Data
Feb. 6, 2006 (JP) JP 2006-028517

(51) Int. Cl. G06F 15/173

(52) U.S. Cl. 709/224

(57) ABSTRACT

A recording medium which is readable by a computer stores a performance analyzing program for searching for a node that is peculiar in performance in a cluster system, as well as unknown problems. The performance analyzing program enables the computer to function as various functional units. A performance data analyzing unit collects performance data of nodes which make up the cluster system from performance data storage unit for storing a plurality of types of performance data of the nodes, and analyzes performance values of the nodes based on the collected performance data. A classifying unit classifies the nodes into a plurality of groups by statistically processing the performance data collected by the performance data analyzing unit according to a predetermined classifying condition. A group performance value calculating unit statistically processes the performance data of the respective groups based on the performance data of the nodes classified into the groups, and calculates statistic values for the respective types of the performance data of the groups. A performance data comparison display unit displays the statistic values of the groups for the respective types of the performance data for comparison between the groups.

### CROSS-REFERENCE TO RELATED APPLICATIONS

This application is based upon and claims the benefits of priority from the prior Japanese Patent Application No. 2006-028517, filed on Feb. 6, 2006, the entire contents of which are incorporated herein by reference.

### BACKGROUND OF THE INVENTION

(1) Field of the Invention

The present invention relates to a computer-readable recording medium with a recorded performance analyzing program for a cluster system, a performance analyzing method, and a performance analyzing apparatus, and more particularly to a computer-readable recording medium with a recorded performance analyzing program for analyzing the performance of a cluster system by statistically processing performance data collected from a plurality of nodes of the cluster system, and a method of and an apparatus for analyzing the performance of such a cluster system.

(2) Description of the Related Art

In the fields of R & D (Research and Development), HPC (High Performance Computing), and bioinformatix, growing use is being made of a cluster system comprising a plurality of computers interconnected by a network, making up a single virtual computer system for parallel data processing. In the cluster system, the individual computers or nodes are interconnected by the network to function as the single virtual computer system. The nodes process given data processing tasks parallel to each other.

The cluster system can be constructed as a high-performance system at a low cost. However, the cluster system requires more nodes if its demanded performance is higher. Cluster systems with a large number of nodes need to be based on a technology for grasping operating states of the nodes.

When a cluster system is in operation, the performance of the cluster system may be analyzed to perform certain tasks. For example, process scheduling can be achieved based on the operational performance of processes that are carried out by a plurality of computers (see, for example, Japanese laid-open patent publication No. 2003-6175).

With the performance of a cluster system being analyzed, should some failure occurs in one of the nodes of the cluster system, it is possible to quickly detect the occurrence of the failure. One system for analyzing the performance of a cluster system displays various items of analytical information as to the cluster system (see Intel Trace Analyzer, [online], Intel Corporation, [searched Jan. 13, 2006], the Internet <URL:http://www.intel.com/cd/software/products/ijkk/jpn/cluster/224160.htm>).

On each of the individual nodes of a cluster system, an operating system and applications are independently activated. Therefore, as many items of information as the number of the nodes are collected for evaluating the cluster system in its entirety. If the cluster system is large in scale, then the amount of information to be processed for system evaluation is so huge that it is difficult to individually determine the operating statuses of the respective nodes and detect a problematic node among those nodes.

According to a major conventional cluster system evaluation process, therefore, the performance values of typical nodes are compared to estimate the operating statuses of the respective nodes. It has been customary to extract a problematic node by setting up a threshold value for data collected on each of the nodes and identifying a node whose collected data has exceeded the threshold value. An attempt has also been made to statistically processing data from respective notes and classifying the processed data to extract important features for performance evaluation (see Dong H. Ahn and Jeffrey S. Vetter, “Scalable Analysis Techniques for Microprocessor Performance Counter Metrics” [online], 2002, [searched Jan. 13, 2006], the Internet <URL:http://www.citeseer.ist.psu.edu/ahn02 scalable.html>).

However, whichever conventional evaluation process is employed, it is difficult to specify a node that is of particular importance as to performance among a number of nodes that make up a large-scale cluster system.

For example, though the evaluation process employing the threshold value is effective to handle a known problem, it is not addressed to unknown problems caused by operational details that are different from those present heretofore. Specifically, using a threshold value needs to analyze, in advance, when to judge a malfunction based on which information has reached what value. However, system failures are frequently caused for unexpected reasons. Because of the rapid progress of hardware performance and the need for improving system operating processes such as security measures at present, it is impossible to predict all causes of failures.

According to Intel Trace Analyzer, [online], Intel Corporation, [searched Jan. 13, 2006], the Internet <URL:http://www.intel.com/cd/software/products/ijkk/jpn/cl uster/224160.htm>, an automatic grouping function based on performance data is not provided. Therefore, for analyzing the performance of a cluster system made up of many nodes, the user has to evaluate a huge amount of data on a trial-and-error basis.

According to Dong H. Ahn and Jeffrey S. Vetter, “Scalable Analysis Techniques for Microprocessor Performance Counter Metrics” [online], 2002, [searched Jan. 13, 2006], the Internet <URL:http://www.citeseer.ist.psu.edu/ahn02scalable.html>, classified results are simply given as feedback to the developer or input to another system, and no consideration is given to the comparison of information between classified groups.

### SUMMARY OF THE INVENTION

It is therefore an object of the present invention to provide a computer-readable recording medium with a recorded performance analyzing program, a performance analyzing method, and a performance analyzing apparatus which are capable of efficiently investigating nodes of a cluster system that are suffering certain peculiar performance behaviors including unknown problems.

To achieve the above object, there is provided in accordance with the present invention a computer-readable recording medium with a recorded performance analyzing program for analyzing the performance of a cluster system. The performance analyzing program enables a computer to function as a performance data analyzing unit for collecting performance data of nodes which make up the cluster system from performance data storage unit for storing a plurality of types of performance data of the nodes, and analyzing performance values of the nodes based on the collected performance data, a classifying unit for classifying the nodes into a plurality of groups by statistically processing the performance data collected by the performance data analyzing unit according to a predetermined classifying condition, a group performance value calculating unit for statistically processing the performance data of the respective groups based on the performance data of the nodes classified into the groups, and calculating statistic values for the respective types of the performance data of the groups, and a performance data comparison display unit for displaying the statistic values of the groups for the respective types of the performance data for comparison between the groups.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic diagram, partly in block form, of an embodiment of the present invention.

FIG. 2 is a diagram showing a system arrangement of the embodiment of the present invention.

FIG. 3 is a block diagram of a hardware arrangement of a management server according to the embodiment of the present invention.

FIG. 4 is a block diagram showing functions for performing a performance analysis.

FIG. 5 is a flowchart of a performance analyzing process.

FIG. 6 is a diagram showing a data classifying process.

FIG. 7 is a diagram showing an example of profiling data of one node.

FIG. 8 is a view showing a displayed example of profiling data.

FIG. 9 is a view showing a displayed example of classified results.

FIG. 10 is a view showing a displayed example of a dispersed pattern.

FIG. 11 is a diagram showing an example of performance data of a CPU.

FIG. 12 is a view showing a displayed image of classified results based on the performance data of CPUs.

FIG. 13 is a view showing a displayed image of classified results when nodes are classified into three groups based on the performance data of the CPUS.

FIG. 14 is a diagram showing scattered patterns.

FIG. 15 is a diagram showing an example of performance data.

FIG. 16 is a view showing a displayed image of classified results based on system-level performance data.

### DESCRIPTION OF THE PREFERRED EMBODIMENT

An embodiment of the present invention will be described below with reference to the drawings.

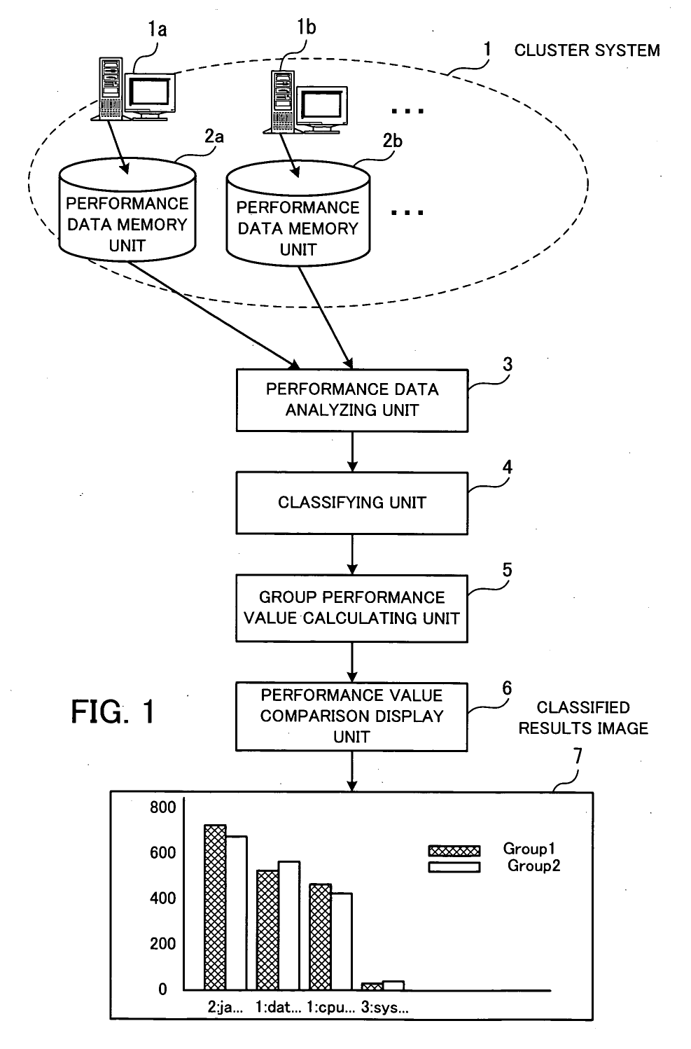

FIG. 1 schematically shows, partly in block form, an embodiment of the present invention.

As shown in FIG. 1, a cluster system 1 comprises a plurality of nodes 1a, 1b, . . . . The nodes 1a, 1b, . . . have respective performance data memory units 2a, 2b, . . . for storing performance data of the corresponding nodes 1a, 1b, . . . .

It is assumed that the individual nodes 1a, 1b, . . . of the cluster system 1 operate identically. For analyzing the performance of the cluster system 1, a performance analyzing apparatus has a performance data analyzing unit 3, a classifying unit 4, a group performance value calculating unit 5, and a performance value comparison display unit 6.

The performance data memory units 2a, 2b, . . . store performance data of the nodes 1a, 1b, . . . of the cluster system 1, i.e., data about performance collectable from the nodes 1a, 1b, . . . . The performance data analyzing unit 3 collects the performance data of the nodes 1a, 1b, . . . from the performance data memory units 2a, 2b, . . . . The performance data analyzing unit 3 can analyze the collected performance data and also can process the performance data depending on the type thereof. For example, the performance data analyzing unit 3 calculates a total value within a sampling time or an average value per unit time, as a performance value, i.e., a numerical value obtained as an analyzed performance result based on the performance data.

The classifying unit 4 statistically processes performance data collected by the performance data analyzing unit 3 and classifies the nodes 1a, 1b, . . . into a plurality of groups under given classifying conditions. There is an initial value (default value) that can be used as the number of groups. If the user does not specify a value as the number of groups, then the nodes are classified into as many groups as the number represented by the initial value, e.g., “2”. If the user specifies a certain value as the number of groups, then the nodes are classified into those groups the number of which is specified by the user.

The group performance value calculating unit 5 statistically processes the performance data of each group based on the performance data of the nodes classified into the groups, and calculates a statistical value for each performance data type of each group. For example, the group performance value calculating unit 5 calculates an average value or the like of the nodes belonging to each group for each performance data type.

The performance value comparison display unit 6 displays the statistical values of the groups in comparison between the groups for each performance data type. For example, the performance value comparison display unit 6 displays a classified results image 7 of a bar chart having bars representing the performance values of the groups. The bars are combined into a plurality of sets corresponding to respective performance data types to allow the user to easily compare the performance values of the groups for each performance data type.

The performance analyzing apparatus thus constructed operates as follows: The performance data memory unit 2a, 2b, . . . store performance data of the nodes 1a, 1b, . . . of the cluster system 1. The performance data analyzing unit 3 collects the performance data of the nodes 1a, 1b, . . . from the performance data memory units 2a, 2b, . . . . The classifying unit 4 analyzes the performance data collected by the performance data analyzing unit 3 and classifies the nodes 1a, 1b, . . . into a plurality of groups under given classifying conditions. The group performance value calculating unit 5 statistically processes the performance data of each group based on the performance data of the nodes classified into the groups, and calculates a statistical value for each performance data type of each group. The performance value comparison display unit 6 displays the statistical values of the groups in comparison between the groups for each performance data type.

As a result, the performance data of the nodes that are collected when the cluster system 1 is in operation are statistically processed, the nodes are classified into a certain number of groups, and the performances of the classified groups, rather than the individual nodes, are compared with each other. Since the performances of the classified groups, rather than the performances of the many nodes, are compared with each other, the processing burden on the performance analyzing apparatus is relatively low. As the performances of the groups are displayed in comparison with each other, a group having a peculiar performance value can easily be identified. When the nodes belonging to the identified group are further classified, a node suffering a certain problem can easily be identified. Consequently, a node suffering a certain problem can easily be identified irrespective of whether the problem occurring in the node is known or unknown.

Details of the present embodiment will be described below.

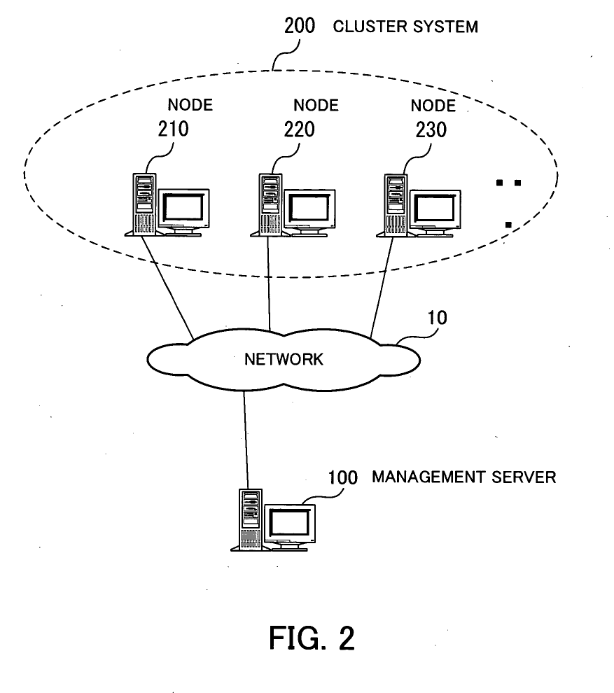

FIG. 2 shows a system arrangement of the present embodiment. As shown in FIG. 2, a cluster system 200 comprises a plurality of nodes 210, 220, 230, . . . . A management server 100 is connected to the nodes 210, 220, 230, . . . through a network 10. The management server 100 collects performance data from the cluster system 200 and statistically processes the collected performance data.

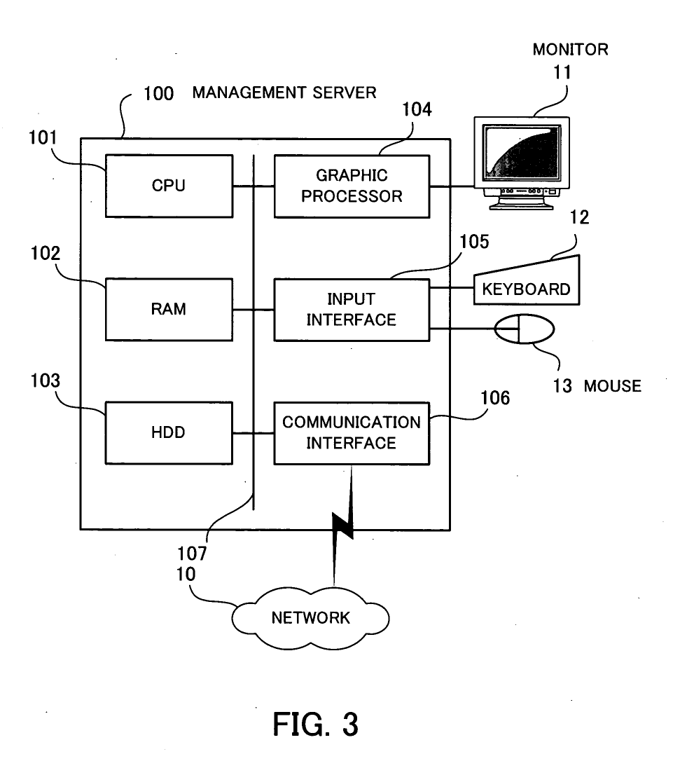

FIG. 3 shows a hardware arrangement of the management server 100 according to the present embodiment. As shown FIG. 3, the management server 100 has a CPU (Central Processing Unit) 101 for controlling itself in its entirety. The management server 100 also has a RAM (Random Access Memory) 102, an HDD (Hard Disk Drive) 103, a graphic processor 104, an input interface 105, and a communication interface 106 which are connected to the CPU 101 through a bus 107.

The RAM 102 temporarily stores at least part of a program of an OS (Operating System) and application programs which are tobeexecutedby the CPU 101. The RAM 102 also stores various data required in processing sequences performed by the CPU 101. The HDD 103 stores the OS and the application programs.

A monitor 11 is connected to the graphic processor 104. The graphic processor 104 displays an image on the screen of the monitor 11 according to an instruction from the CPU 101. A keyboard 12 and a mouse 13 are connected to the input interface 105. The input interface 105 sends signals from the keyboard 12 and the mouse 13 to the CPU 101 through the bus 107.

The communication interface 106 is connected to the network 10. The communication interface 106 sends data to and receives data from another computer through the network 10.

The hardware arrangement of the management server 100 shown in FIG. 3 performs the processing functions according to the present embodiment. FIG. 3 shows only the hardware arrangement of the management server 100. However, each of the nodes 210,220, 230, maybe implemented by the same hardware arrangement as the one shown in FIG. 3.

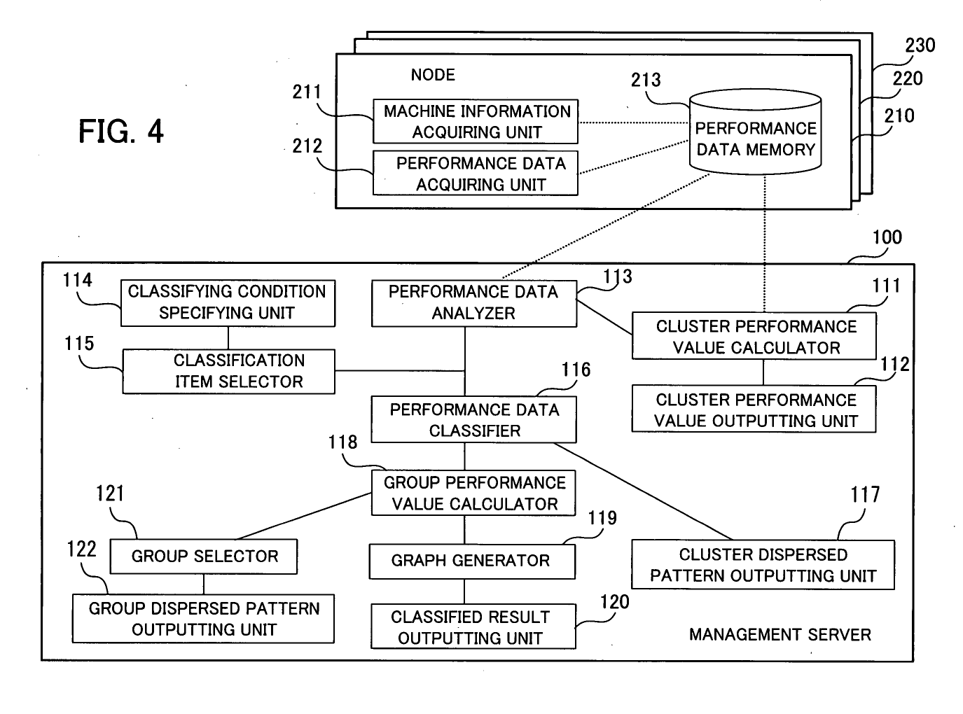

FIG. 4 shows in block form functions for performing a performance analysis. In FIG. 4, the functions of the node 210 and the management server 100 are illustrated.

As shown in FIG. 4, the node 210 has a machine information acquiring unit 211, a performance data acquiring unit 212, and a performance data memory 213.

The machine information acquiring unit 211 acquires machine configuration information (hardware performance data) of the node 210, which can be expressed by numerical values, as performance data, using functions provided by the OS or the like. The hardware performance data include the number of CPUs, CPU operating frequencies, and cache sizes. The machine information acquiring unit 211 stores the acquired machine configuration information into the performance data memory 213. The machine configuration information is used as a classification item if the cluster system is constructed of machines having different performances or if the performance values of different cluster systems are to be compared with other.

The performance data acquiring unit 212 acquires performance data (execution performance data) that can be measured when the node 210 actually executes a processing sequence. The execution performance data include data representing execution performance at a CPU level, e.g., an IPC (Instruction Per Cycle), and data (profiling data) representing the number of events such as execution times and cache misses, collected at a function level. These data can be collected using any of various system management tools such as a profiling tool or the like. The performance data acquiring unit 212 stores the collected performance data into the performance data memory 213.

The performance data memory 213 stores hardware performance data and execution performance data as performance data.

The management server 100 comprises a cluster performance value calculator 111, a cluster performance value outputting unit 112, a performance data analyzer 113, a classifying condition specifying unit 114, a classification item selector 115, a performance data classifier 116, a cluster dispersed pattern outputting unit 117, a group performance value calculator 118, a graph generator 119, a classified result outputting unit 120, a group selector 121, and a group dispersed pattern outputting unit 122.

The cluster performance value calculator 111 acquires performance data from the performance data memories 213 of the respective nodes 210, 220, 230, . . . , and calculates a performance value of the entire cluster system 200. The cluster performance value calculator 111 supplies the calculated performance value to the cluster performance value outputting unit 112 and the performance data analyzer 113.

The cluster performance value outputting unit 112 outputs the performance value of the cluster system 200 which has been received from. the cluster performance value calculator 111 to the monitor 11, etc.

The performance data analyzer 113 collects performance data from the performance data memories 213 of the respective nodes 210, 220, 230, . . . , and processes the collected performance data as required. The performance data analyzer 113 supplies the processed performance data to the performance data classifier 116.

The classifying condition specifying unit 114 receives classifying conditions input by the user through the input interface 105. The classifying condition specifying unit 114 supplies the received classifying conditions to the classification item selector 115.

The classification item selector 115 selects a classification item based on the classifying conditions supplied from the classifying condition specifying unit 114. The classification item selector 115 supplies the selected classification item to the performance data classifier 116.

The performance data classifier 116 classifies nodes according to a hierarchical grouping process for producing hierarchical groups. The hierarchical grouping process, also referred to as a hierarchical cluster analyzing process, is a process for processing a large amount of supplied data to classify similar data into a small number of hierarchical groups. The performance data classifier 116 supplies the classified groups to the cluster dispersed pattern outputting unit 117 and the group performance value calculator 118.

The cluster dispersed pattern outputting unit 117 outputs dispersed patterns of various performance data of the entire cluster system 200 to the monitor 11, etc.

The group performance value calculator 118 calculates performance values of the respective classified groups. The group performance value calculator 118 supplies the calculated performance values to the graph generator 119 and the group selector 121.

The graph generator 119 generates a graph representing the performance values for the user to visually compare the performance values of the groups. The graph generator 119 supplies the generated graph data to the classified result outputting unit 120.

The classified result outputting unit 120 displays the graph on the monitor 11 based on the supplied graph data.

The group selector 121 selects one of the groups based on the classified results output from the classified result outputting unit 120.

The group dispersed pattern outputting unit 122 generates and outputs a graph representative of dispersed patterns of the performance values in the group selected by the group selector 121.

The management server 100 thus arranged analyzes the performance of the cluster system 200. The management server 100 is capable of detecting a faulty node more reliably by repeating the performance comparison between the groups while changing the number of classified groups and items to be classified. For example, if the cluster system 200 fails to provide its performance as designed, then the management server 100 analyzes the performance of the cluster system 200 according to a performance analyzing process to be described below.

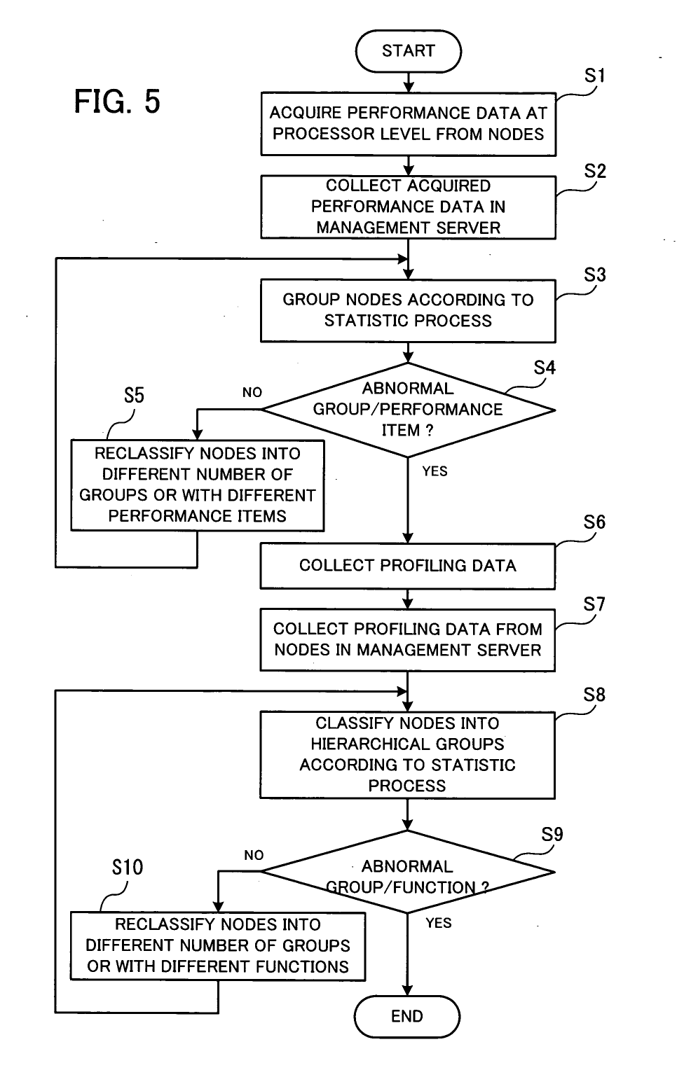

FIG. 5 is a flowchart of a performance analyzing process. The performance analyzing process, which is shown by way of example in FIG. 5, extracts an abnormal node group and a performance item of interest according to a classifying process using performance data at the CPU level, and identifies an abnormal node group and an abnormal function group according to a classifying process using profiling data. The performance analyzing process shown in FIG. 5 will be described in the order of successive steps.

[Step S1] The performance data acquiring units 212 of the respective nodes 210, 220, 230, . . . of the cluster system 200 acquire performance data at the CPU level and store the acquired performance data in the respective performance data memories 213.

[Step S2] The performance data analyzer 113 of the management server 100 collects the performance data, which the performance data acquiring units 212 have acquired, from the performance data memories 213 of the respective nodes 210, 220, 230, . . . .

[Step S3] The performance data classifier 116 classifies the nodes 210, 220, 230, . . . into a plurality of groups based on the statistically processed results produced from the performance data. The nodes 210, 220, 230, . . . may be classified into hierarchical groups, for example.

[Step S4] The group performance value calculator 118 calculates performance values of the respective classified groups. Based on the calculated performance values, the graph generator 119 generates a graph for comparing the performance values of the groups, and the classified result outputting unit 120 displays the graph on the monitor 11. Based on the displayed graph, the user determines whether there is a group exhibiting an abnormal performance or not or there is an abnormal performance item or not. If an abnormal performance group or an abnormal performance item is found, then control goes to step S6. If an abnormal performance group or an abnormal performance item is not found, then control goes to step S5.

[Step S5] The user enters a control input to change the number of groups or the performance item into the classifying condition specifying unit 114 or the classification item selector 115. The changed number of groups or performance item is supplied from the classifying condition specifying unit 114 or the classification item selector 115 to the performance data classifier 116. Thereafter, control goes back to step S3 in which the performance data classifier 116 classifies the nodes 210, 220, 230, . . . again into a plurality of groups.

As described above, the performance data at the CPU level are collected, the nodes are classified into groups based on the collected performance data, and an abnormal node group is extracted. Initially, the nodes are classified according to default classifying conditions, e.g., the number of groups: 2, and a recommended performance item group for each CPU, and the dispersed pattern of the groups and the performance difference between the groups are confirmed.

If the performance difference between the groups is small and the dispersed pattern of the groups is small, then the node classification is ended, i.e., it is judged that there is no abnormal node group.

If the performance difference between the groups is large and the dispersed pattern of the groups is small, then the node classification is ended, i.e., it is judged that there is some problem occurring in a group whose performance is extremely poor.

If the dispersed pattern of the groups is large, then the number of groups is increased, and the nodes are classified again. If the performance difference between the groups is large, then attention is directed to a group whose performance is poor. Furthermore, attention may be directed to performance items whose performance difference is large, and measured data used for node classification may be limited to only the performance items whose performance difference is large.

After a certain problematic group has been identified based on the performance data of the CPUs, control goes to step S6.

[Step S6] The performance data acquiring units 212 of the respective nodes210, 220, 230, of the cluster system 200 collect profiling data with respect to a problematic performance item, and stores the collected profiling data in the respective performance data memories 213.

[Step S7] The performance data analyzer 113 of the management server 100 collects the profiling data, which the performance data acquiring units 212 have collected, from the performance data memories 213 of the respective nodes 210, 220, 230, . . . .

[Step S8] The performance data classifier 116 classifies the nodes 210, 220, 230, . . . into a plurality of groups based on the statistically processed results produced from the profiling data. The nodes 210, 220, 230, . . . may be classified into hierarchical groups, for example.

[Step S9] The group performance value calculator 118 calculates performance values of the respective classified groups. Based on the calculated performance values, the graph generator 119 generates a graph for comparing the performance values of the groups, and the classified result outputting unit 120 displays the graph on the monitor 11. Based on the displayed graph, the user determines whether there is a group exhibiting an abnormal performance or not or there is an abnormal function or not. If an abnormal performance group or an abnormal function is found, then the processing sequence is put to an end. If an abnormal performance group or an abnormal function is not found, then control goes to step S10.

[Step S10] The user enters a control input to change the number of groups or the function into the classifying condition specifying unit 114 or the classification item selector 115. The changed number of groups or function item is supplied from the classifying condition specifying unit 114 or the classification item selector 115 to the performance data classifier 116. Thereafter, control goes back to step S8 in which the performance data classifier 116 classifies the nodes 210, 220, 230, . . . again into a plurality of groups.

As described above, the profiling data are collected with respect to execution times or a problematic performance item, e.g., the number of cache misses, and the nodes are classified into groups based on the collected profiling data. Initially, the nodes are classified according to default classifying conditions, e.g., the number of groups: 2, and execution times of 10 higher-level functions or the number of times that a measured performance item occurs, and the dispersed pattern of the groups and the performance difference between the groups are confirmed in the same manner as with the performance data at the CPU level. The number of functions and functions of interest to be used when the nodes are classified again may be changed.

For example, if a group having a cache miss ratio greater than other groups is found in a CPU level analysis, then profiling data of cache miss counts are collected. By classifying the nodes according to the cache miss count for each function, it is possible to determine which function of which node is executed when many cache misses are caused.

If a group having a poor CPI (the number of CPU clock cycles required to execute one instruction), which represents a typical performance index, is found and other performance items responsible for such a poor CPI are not found, then profiling data of execution times are collected. By classifying the nodes according to the execution time of each function, a node and a function which takes a longer execution time than normal node groups can be identified.

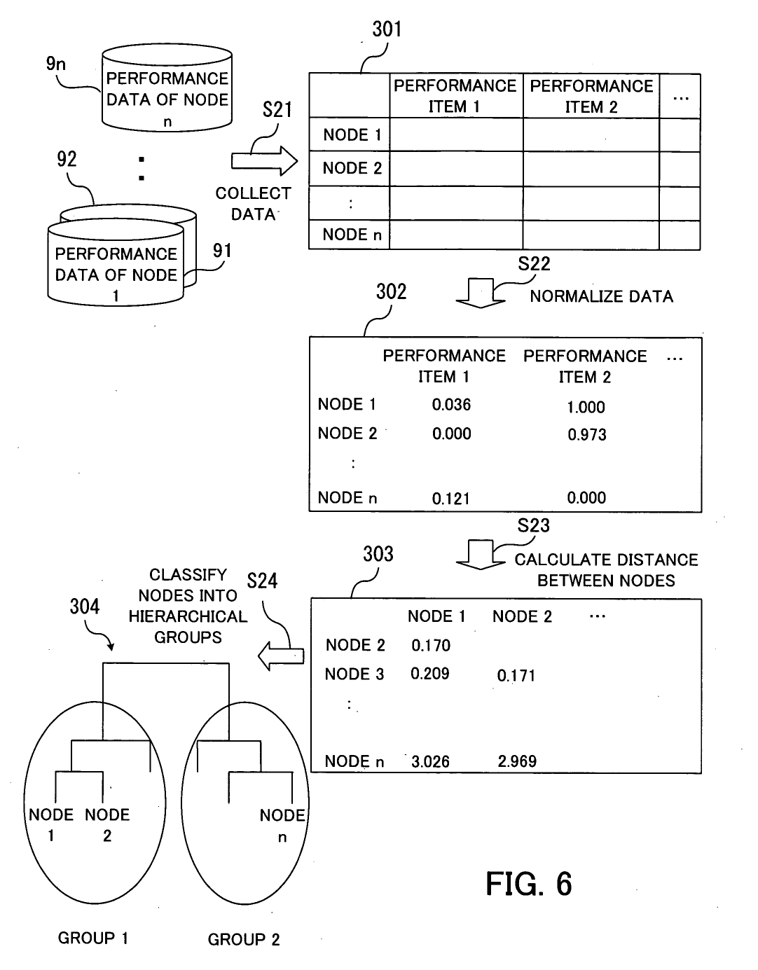

FIG. 6 is a diagram showing a data classifying process. According to the data classifying process shown in FIG. 6, the performance data analyzer 113 collects performance data 91, 92, 93, . . . , 9n required by the respective nodes of the cluster system, and tabulates the collected performance data 91, 92, 93, . . . , 9n in a performance data table 301 (step S21). The performance data classifier 116 normalizes the performance data 91, 92, 93, , 9n collected from the nodes to allow the performance data which are expressed in different units to be compared with each other, and generates a normalized data table 302 of the normalized performance data (step S22). In FIG. 6, the performance data classifier 116 normalizes the performance data 91, 92, 93, . . . , 9n between maximum and minimum values, i.e., makes calculations to change the values of the performance data 91, 92, 93, ., 9n such that their maximum value is represented by 1 and their minimum value by 0. The performance data classifier 116 enters the normalized data into a statistically processing tool, and determines a matrix of distances between the nodes, thereby generating a distance matrix 303 (step S23). The performance data classifier 116 enters the distance matrix and the number of groups to be classified into the tool, and produces classified results 304 representing hierarchical groups (step S24).

The performance data classifier 116 may alternatively classify the nodes according to a non-hierarchical process such as the K-means process for setting objects as group cores and forming groups using such objects. If a classification tool according to the K-means process is employed, then a data matrix and the number of groups are given as input data.

By comparing the performance values of the respective groups thus classified, a group including a faulty node can be identified.

Examples of comparison between the performance values of classified groups if the performance data acquired from the nodes of a cluster system are profiling data representing the execution times of functions, performance data of CPUs, and system-level performance data obtained from OSs, will be described in specific detail.

First, an example in which the nodes are classified using profiling data will be described below. Checking details of functions executed in the nodes within a certain period of time or when a certain application is executed is easy for the user to understand and is liable to identify areas to be tuned.

First, the performance data analyzer 113 collects the execution times of functions from the nodes 210, 220, 230, . . . .

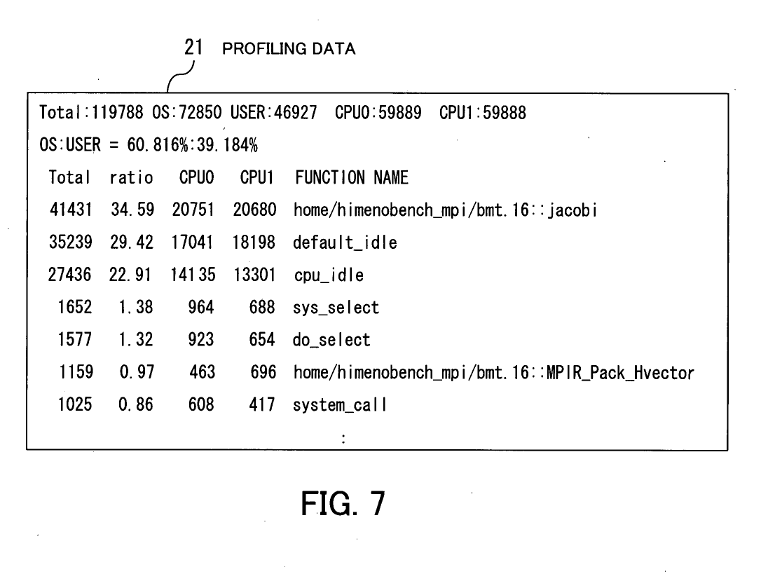

FIG. 7 shows an example of profiling data of one node. As shown in FIG. 7, profiling data 21 include a first row representing type-specific details of execution times and CPU details. “Total: 119788” indicates a total calculation time in which the profiling data 21 are collected. “OS:72850” indicates a time required to process the functions of the OS. “USER:46927” indicates a time required to process functions executed in a user process. “CPU0:59889” and “CPU1:59888” indicate respective calculation times of two CPUs on the node.

The profiling data 21 include a second row representing an execution ratio of an OS level function (kernel function) and a user (USER) level function (user-defined function). Third and following rows of the profiling data 21 represent function information. The function information is indicated by “Total”, “ratio”, “CPUO”, “CPU1”, and “function name”. “Total” refers to an execution time required to process a corresponding function. “Ratio” refers to the ratio of a processing time assigned to the processing of a corresponding function. “CPU0” and“CPU1” refer to respective times in which corresponding functions are processed by individual CPUs. “Function name” refers to the name of a function that has been executed. The profiling data 21 thus defined are collected from the nodes.

The performance data analyzer 113 analyzes the collected performance data and sorts the data according to the execution times of functions with respect to each of all functions or function types such as a kernel function and a user-defined function. In the example shown in FIG. 7, the performance data are sorted with respect to all functions. The performance data analyzer 113 calculates the performance data as divided according to a kernel functions and a user-defined function.

Then, the performance data analyzer 113 supplies only the sorted data of a certain number of higher-level functions to the performance data classifier 116. Usually at a function level, a considerable number of functions are executed. However, not all the functions are equally executed, but it often takes time to execute certain functions. According to the present invention, therefore, only functions which account for a large proportion to the total execution time are to be classified.

The cluster performance value calculator 111 calculates a performance value of the cluster system 200. The performance value may be the average value of the performance data of all the nodes or the sum of the performance data of all the nodes. The calculated performance value of the cluster system 200 is output from the cluster performance value outputting unit 112. From the output performance value of the cluster system 200, the user is able to recognize the general operation of the cluster system 200.

The performance data from which the performance value is to be calculated may be default values used to classify the nodes or classifying conditions specified by the user with the classifying condition specifying unit 114.

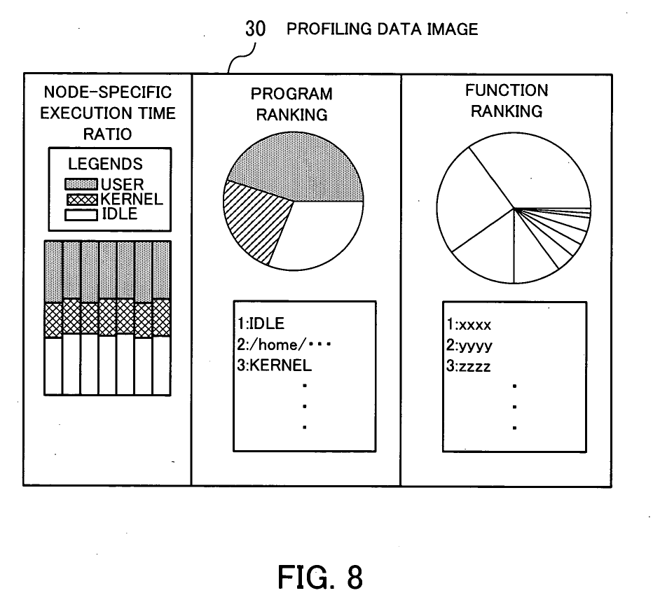

FIG. 8 shows a displayed example of profiling data. As shown in FIG. 8, a displayed image 30 of profiling data comprises 8-node cluster system profiling data including type-specific execution time ratios for the nodes, a program ranking in the entire cluster execution time, and a function ranking in the entire cluster execution time. The profiling data image 30 thus displayed allows the user to recognize the general operation of the cluster system 200.

The classifying condition specifying unit 114 accepts specifying input signals from the user with respect to a normalizing process for performance data, the number of groups into which the nodes are to be classified, the types of functions to be used for classifying the nodes, and the number of functions to be used for classifying the nodes. If functions and nodes of interest are already known to the user, then they may directly be specified using function names and node names.

Based on the normalizing process accepted by the classifying condition specifying unit 114, the performance data classifier 116 normalizes measured values of the performance data. For example, the performance data classifier 116 normalizes each measured value with maximum/minimum values or an average value/standard deviation in the node groups of the cluster system 200. The execution times of functions are expressed according to the same unit and may not necessarily need to be normalized.

The nodes are classified based on the performance data for the purpose of discovering an abnormal node group. The number of groups that is considered to be appropriate is 2. Specifically, if the nodes are classified into two groups and there is no performance difference between the groups, then no abnormal node is considered to be present.

For grouping the nodes, those nodes which are similar in performance are classified into one group. If the nodes are classified into a specified number of groups, there is a performance difference between the groups, and the dispersion in each of the groups is not large, then the number of groups is considered to be appropriate.

If the dispersion in a group is large, i.e., if the nodes in the group do not have much performance in common, then the nodes are classified into an increased number of groups. If there is not a significant performance difference between the groups, i.e., if nodes which are close in performance to each other belong to differentgroups, then the number of groups is reduced.

The nodes may have their operation patterns known in advance. For example, the nodes are divided into managing nodes and calculating nodes, or the nodes are constructed of machines which are different in performance from each other. In such a case, the number of groups that are expected according to the operation patterns may be specified.

If it is found as a result of node classification that grouping is not proper and the dispersion in groups is large, then the nodes are classified into an increased number of groups. Such repetitive node classification makes the behavior of the cluster system clear.

The classification item selector 115 selects only those of the performance data analyzed by performance data analyzer 113 which match the conditions that are specified by the user with the classifying condition specifying unit 114. If there is no specified classifying condition, then the classification item selector 115 uses default classifying conditions. The default classifying conditions may include, for example, the number of groups: 2, execution times of 10 higher-level functions, and all nodes.

The performance data classifier 116 classifies the nodes according to a hierarchical grouping process for producing a hierarchical array of groups. Since there exists a tool for providing such a classifying process, the existing classification tool is used.

Specifically, the performance data classifier 116 normalizes specified performance data according to a specified normalizing process, calculates distances between normalized data strings, and determines a distance matrix. The performance data classifier 116 inputs the distance matrix, the number of groups into which the nodes are to be classified, and a process of defining a distance between clusters, to the classification tool, which classifies the nodes into the specified number of groups. The process of defining a distance between clusters may be a shortest distance process, a longest distance process, or the like, and may be specified by the user.

The group performance value calculator 118 calculates a performance value of each of the groups into which the nodes have been classified. The performance value of each group may be the average value of the performance data of the nodes which belong to the group, the value of the representative node of the group, or the sum of the values of all the nodes which belong to the group. The representative node of a group may be a node having an average value of performance data.

The grouping of the nodes and the performance value of the groups which are calculated by the group performance value calculator 118 are output from the classified result outputting unit 120. At this time, the graph generator 119 can generate a graph for comparing the groups with respect to each performance data and can output the generated graph. The graph output from the graph generator 119 allows the user to recognize the classified results easily.

The classified results represented by the graph may simply be in the form of an array of the values of the groups with respect to each performance data. Alternatively, the graph may use the performance value of the group made up of a greatest number of nodes as a reference value, and represent proportions of the performance values of the other group with respect to the reference value for allowing the user to compare the groups easily.

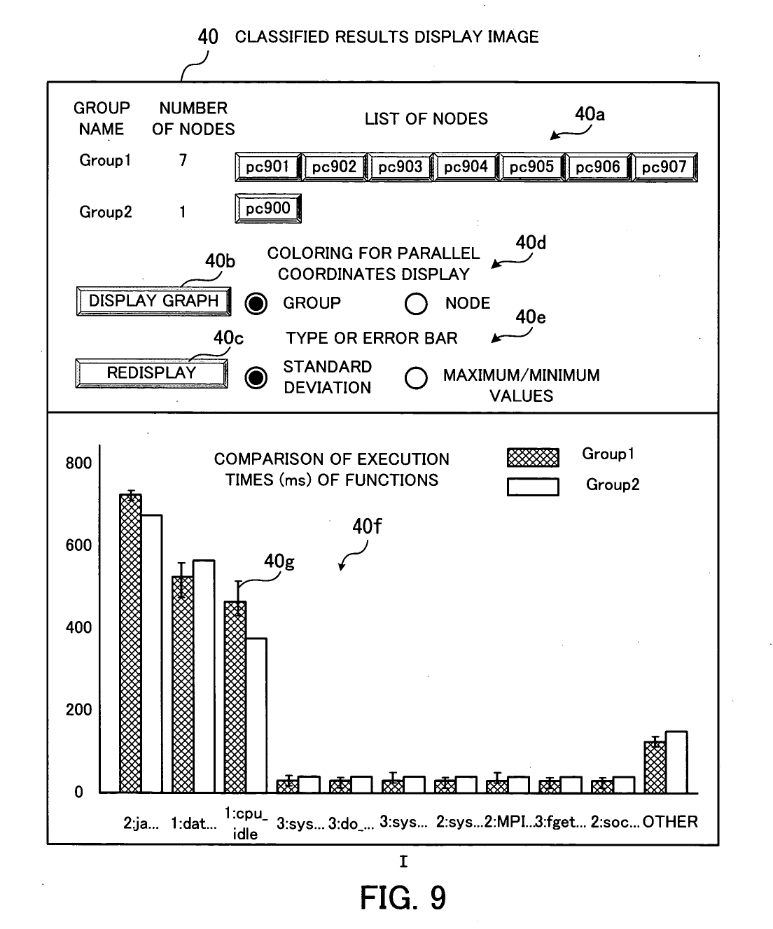

FIG. 9 shows a displayed example of classified results. As shown in FIG. 9, a classified results display image 40 includes classified results produced by normalizing the profiling data shown in FIG. 8 with an average value/standard deviation, and classifying the data as the execution times of 10 higher-level functions into two groups (Group1, Group2).

In the classified results display image 40, a group display area 40a displays the group names of the respective groups, the numbers of nodes of the groups, and the node names belonging to the groups. In the example shown in FIG. 9, the nodes are classified into a group (Group1) of seven nodes and a group (Group2) of one node.

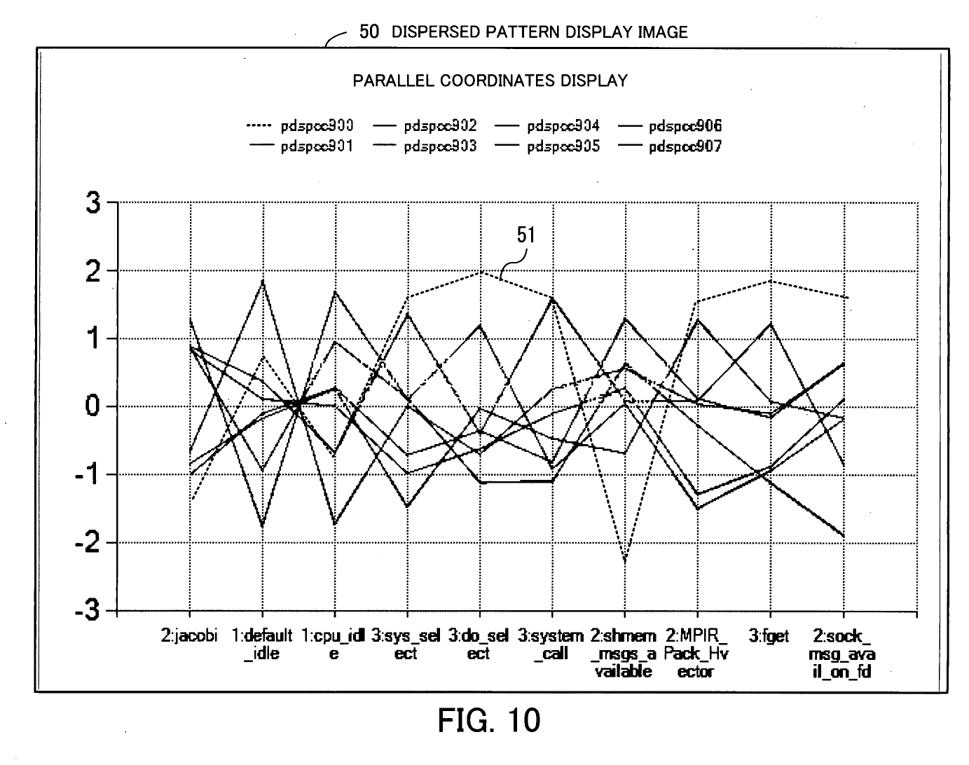

When a graph display button 40b is pressed, a dispersed pattern display image 50 (see FIG. 10) is displayed. Check boxes 40d for indicating coloring for parallel coordinates display patterns may be used to indicate coloring references in the graph. For example, when the check box 40d “GROUP” is selected, the groups are displayed in different colors.

When a redisplay button 40c is pressed, a graph 40f is redisplayed. Check boxes 40e for selecting types of error bars may be used to select an error bar 40g as displaying a standard deviation or maximum/minimum values.

The graph 40f shown in FIG. 9 is a bar graph showing the average values of the performance values of the groups. Black error bars 40g are displayed as indicating standard deviation ranges representative of the dispersed patterns of the groups. In the example shown in FIG. 9, only one node belongs to Group 2, and there is no standard deviation range for Group 2.

It can be seen from the example shown in FIG. 9 that through the groups have different idling patterns (1:cpu_idle), but the difference is not significantly large.

Dependent on a control input entered by the user, the group selector 121 selects one group from the classified results output from the classified result outputting unit 120. When the group selector 121 selects one group, the group dispersed pattern outputting unit 122 generates a graph representing a dispersed pattern of performance values in the selected group, and outputs the generated graph. The graph representing a dispersed pattern of performance values in the selected group may be a bar graph of performance values of the nodes in the selected group or a histogram representing a frequency distribution if the number of nodes is large. Based on the graph, the dispersed pattern of performance values in the selected group may be recognized, and, if the dispersion is large, then the number of groups may be increased, and the nodes may be reclassified into the groups.

The cluster dispersed pattern outputting unit 117 may also be used to review a dispersed pattern of performance values of the nodes. Specifically, the cluster dispersed pattern outputting unit 117 generates and outputs a graph representing differently colored groups that have been classified by the performance data classifier 116. The graph may be a parallel coordinates display graph representing normalized performance values or a scatter graph representing a distribution of performance data.

FIG. 10 shows a displayed example of a dispersed pattern. As shown in FIG. 10, the dispersed pattern display image 50 represents parallel coordinates display patterns of data classified as shown in FIG. 9. In FIG. 10, 0 on the vertical axis represents an average value and ±1 represents a standard deviation range. Functions are displayed in a descending order of execution times. For example, a line 51 representing the nodes classified into Group1 indicates that first and seventh functions have shorter execution times and fourth through sixth functions and eighth through tenth functions have longer execution times.

A process of classifying nodes using performance data obtained from CPUs will be described below.

The performance data acquiring unit 212 collects performance data obtained from CPUs, such as the number of executing instructions, the number of cache misses, etc.

The performance data analyzer 113 analyzes the collected performance data and calculates a performance value such as a cache miss ratio representing the proportion of the number of cache misses in the number of executing instructions.

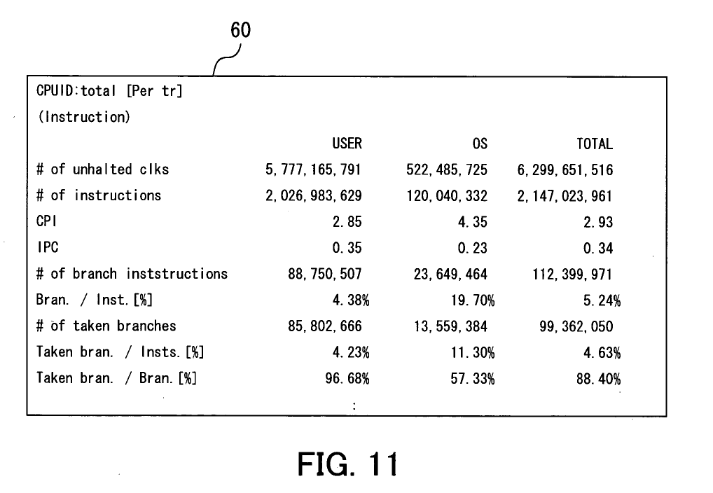

FIG. 11 shows an example of performance data 60 of a CPU. The performance data 60 may be obtained not only as an actual count of some events, but also as a numerical value representing a proportion of such events. If a proportion of events occurring per node has already been calculated, it does not need to be calculated again. For producing statistical values in a group, it is necessary to collect the values of the nodes.

The cluster performance value calculator 111 calculates an-average value of performance data of all nodes or a sum of performance data of all nodes as a performance value of the cluster system, for example. Data obtained from CPUs maybe expressed as proportions (%). In such a case, an average value is used.

The cluster performance value outputting unit 112 displays an average value such as a CPI or a CPU utilization ratio which is a representative performance item indicative of the performance of CPUs.

The classifying condition specifying unit 114 allows the user to specify a process of normalizing performance data, the number of groups into which nodes are to be classified, and performance items to be used for classification. Since a node of interest may be known in advance, the classifying condition specifying unit 114 may allow the user to specify a node to be classified. Measured values may be normalized with maximum/minimum values or an average value/standard deviation in the node groups of the cluster system. The data obtained from the CPUs need to be normalized because their values may be expressed in different units and scales depending on the performance items.

The classification item selector 115 selects only those of the performance data which match the conditions that are specified by the user with the classifying condition specifying unit 114. If there is no specified classifying condition, then the classification item selector 115 uses default classifying conditions. The default classifying conditions may include, for example, the number of groups: 2 and all nodes. The performance items include a CPI, a CPU utilization ratio, a branching ratio representing the proportion of the number of branching instructions to the number of executing instructions, a branch prediction miss ratio with respect to branching instructions, an instruction TLB (I-TLB) miss occurrence ratio with respect to the number of instructions, a data TLB (D-TLB) miss occurrence ratio with respect to the number of instructions, a cache miss ratio, a secondary cache miss ratio, etc. Performance items that can be collected may differ depending on the type of CPUs, and default values are prepared for each CPU which has different performance items.

The performance value of a group which is calculated by the group performance value calculator 118 is generally considered to be an average value of performance values of the nodes belonging to the group, a value of the representative node of the group, or a sum of performance values of the nodes belonging to the group. Since some data obtained from CPUs may be expressed as proportions (%) depending on the performance item, the sum of performance values of the nodes belonging to a group is not suitable as the performance value calculated by the group performance value calculator 118.

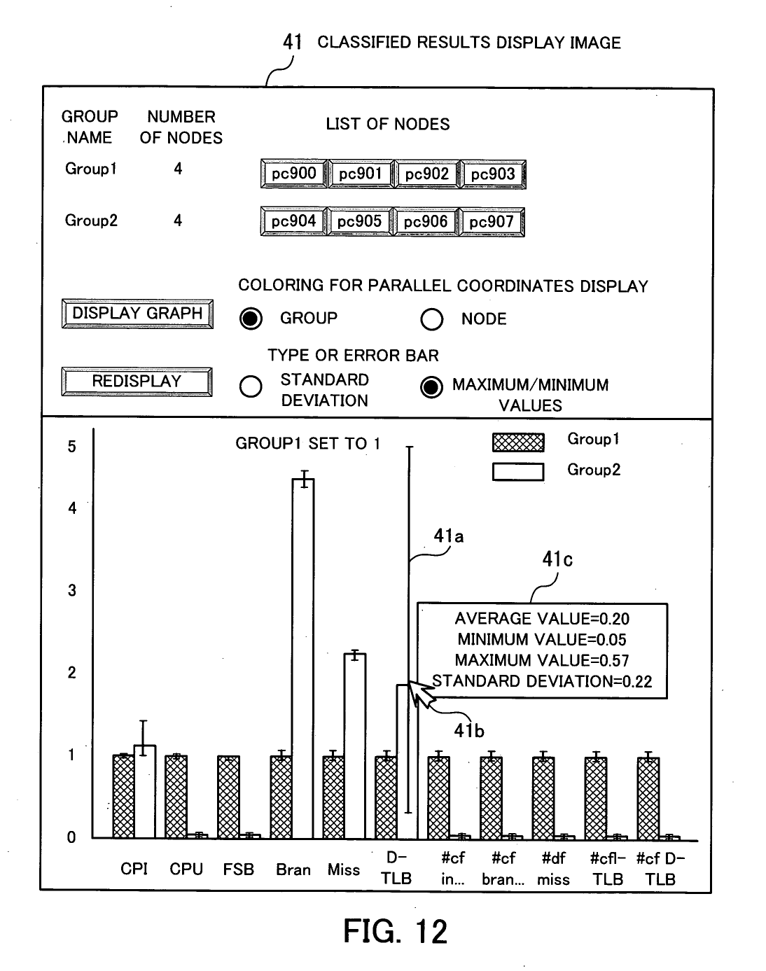

FIG. 12 shows a displayed example of classified results when the nodes are classified into two groups based on the performance data of CPUs. As shown in FIG. 12, a classified results display image 41 includes classified results produced by classifying into two groups 8 nodes composing a cluster system, based on 11 items of the performance data of CPUs that are collected from the cluster system.

It can be seen from the example shown in FIG. 12 that the eight nodes are classified into two groups (Group1, Group2) of four nodes and nothing is executed in the nodes belonging to Group2 because the CPU utilization ratio of Group2 is almost 0. In the classified results display image 41, a dispersed pattern in each of the groups is indicated by an error bar 41a which represents a range of maximum/minimum values.

In the example shown in FIG. 12, the dispersion in the group of the D-TLB miss occurrence ratio (indicated by “D-TLB” in FIG. 12) is large. However, the dispersion should not be taken significantly as its values (an average value of 0.01, a minimum value of 0.05, and a maximum value of 0.57) are small. When any of the bars is pointed by a mouse cursor 41b, values of the group (an average value, a minimum value, a maximum value, and a standard deviation) are displayed as a tool tip 41c for the user to recognize details.

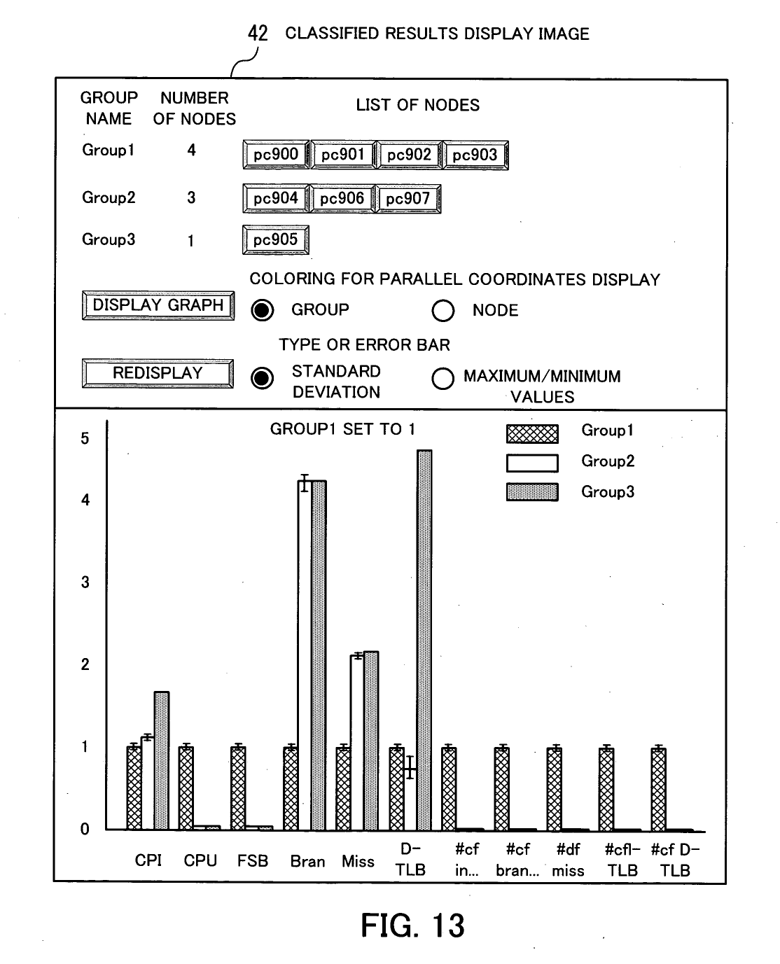

FIG. 13 shows a displayed example of classified results produced when the nodes are classified into three groups based on the performance data of CPUs. In the example shown in FIG. 13, the data shown in FIG. 12 are classified into three groups. It can be seen from a classified results display image 42 shown in FIG. 13 that one node is divided from the group in which nothing is executed, and the node is responsible for an increased dispersion of D-TLB miss occurrence ratios.

A comparison between the examples shown in FIGS. 12 and 13 indicates that the nodes may be classified into two groups if a node group in which a process is executed and a node group in which a process is not executed are to be distinguished from each other. It can also be seen that when the dispersion of certain performance data is large, if a responsible node is to be ascertained, then the number of groups into which the nodes are classified may be increased.

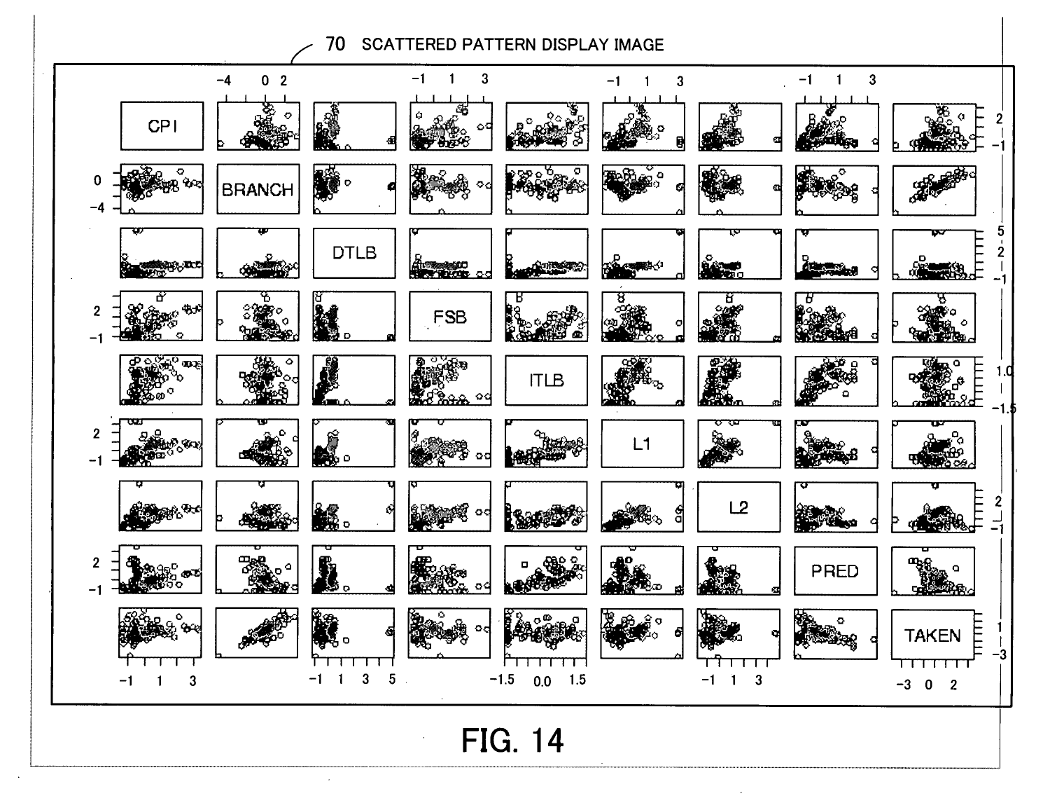

FIG. 14 shows scattered patterns. The scattered patterns are generated by the cluster dispersed pattern outputting unit 117. In the illustrated example, one scattered pattern is generated from the values of two performance items that have been normalized with an average value/standard deviation, and scattered patterns of respective performance items used to classify the nodes are arranged in a scattered pattern display image 70. In each of the scattered patterns, the performance data of nodes are plotted with dots in different colors for different groups to allow the user to see the tendencies of the groups. For example, if dots plotted in red are concentrated on low CPI values, then it can be seen that the CPI values of the group are small.

A process of classifying nodes using performance data at the system level, i.e., data representing the operating situations of operating systems, will be described below.

The performance data acquiring unit 212 collects performance data at the system level, such as the amounts of memory storage areas used, the amounts of data that have been input and output, etc. These data can be collected using commands provided by OSs and existing tools.

Since these data are usually collected at given time intervals, the performance data analyzer 113 analyzes the collected performance data and calculates a total value within the collecting time or an average value per unit time as a performance value.

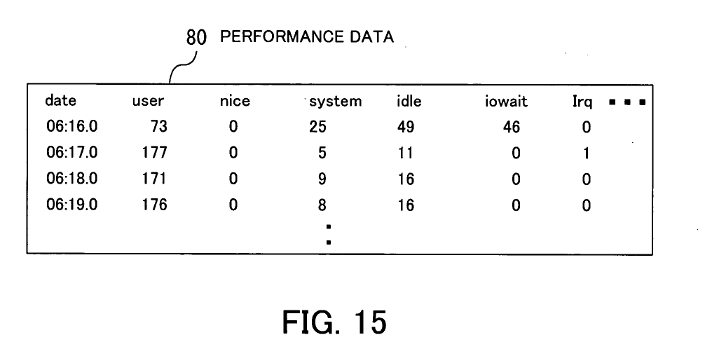

FIG. 15 shows an example of performance data. As shown in FIG. 15, performance data 80 have a first row serving as a header and second and following rows representing collected data at certain dates and times. In the illustrated example, the data are collected at 1-second intervals.

The performance data that are collected include various data such as CPU utilization ratios of the entire nodes, CPU utilization ratios of respective CPUs in the nodes, the amounts of data input to and output from disks, the amount of memory storage areas, etc.

The cluster performance value calculator 111 calculates an average value of performance data of all nodes or a sum of performance data of all nodes as a performance value of the cluster system, for example. Data obtained at the system level may be expressed as proportions (%). In such a case, an average value is used.

The cluster performance value outputting unit 112 displays an average value in the cluster system of representative performance items. With respect to a plurality of resources including a CPU, an HDD, etc. that exist per node, the cluster performance value outputting unit 112 displays average values of the respective resources and an average value of all the resources for the user to confirm. If a total value of data, such as amounts of data input to and output from disks, can be determined, then a total value for each of the entire disks and a total value for the entire cluster system may be displayed.

The classifying condition specifying unit 114 allows the user to specify a normalizing process for performance data, the number of groups into which the nodes are to be classified, and performance items to be used for classifying the nodes. If nodes of interest are already known to the user, then the user may be allowed to specify nodes to be processed.

Measured values may be normalized with maximum/minimum values or an average value/standard deviation in the node groups of the cluster system. The data obtained at the system level need to be normalized because their values may be expressed in different units and scales depending on the performance items.

The classification item selector 115 selects only those of the performance data which match the conditions that are specified by the user with the classifying condition specifying unit 114. If there is no specified classifying condition, then the classification item selector 115 uses default classifying conditions. The default classifying conditions may include, for example, the number of groups: 2, all nodes, and performance items including a CPU utilization ratio, an amount of swap, the number of inputs and outputs, an amount of data that are input and output, an amount of memory storage used, and an amount of data sent and received through the network. The CPU utilization ratio is defined as an executed proportion of “user”, “system”, “idle”, or “iowait”.

If a plurality of CPUs are used in one node, then the value of each of the CPUs or the proportion of the sum of the values of the CPUs is used. If a plurality of disks are connected to one node, then the number of inputs and outputs and the amount of data that are input and output may be represented by the value of each of the disks, an average value of all the disks, or a sum of the values of the disks. The same holds true if a plurality of network cards are installed on one node.

Usually, the entire collecting time is to be processed. However, if a time of interest is known, then the time can be specified. If a collection start time at each node is known, then not only a relative time from the collection start time, but also an absolute time in terms of a clock time may be specified to handle different collection start times at respective nodes.

The performance value of a group which is calculated by the group performance value calculator 118 is generally considered to be an average value of performance values of the nodes belonging to the group, a value of the representative node of the group, or a sum of performance values of the nodes belonging to the group. Since some data obtained at the system level may be expressed as proportions (%) depending on the performance item, the sum of performance values of the nodes belonging to a group is not suitable as the performance value calculated by the group performance value calculator 118.

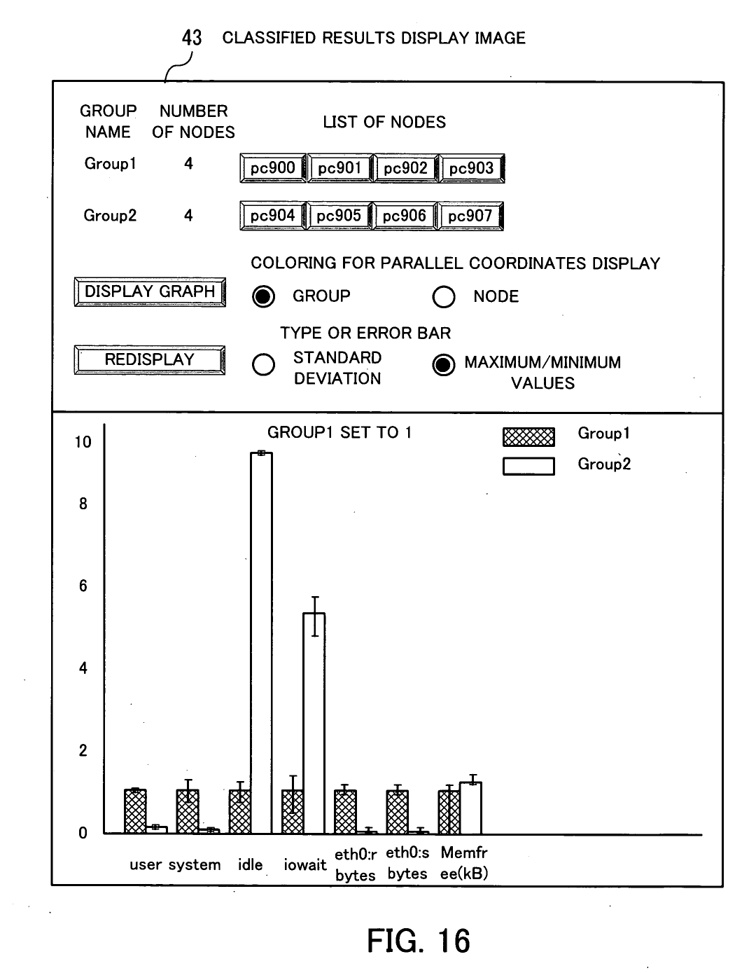

FIG. 16 shows a displayed image of classified results based on system-level performance data. In the example shown in FIG. 16, performance data collected when the same application is executed in the same cluster system as with the data obtained from the CPU are employed. In a classified results display image 43 shown in FIG. 16, the nodes are divided into two groups in the same manner as shown in FIG. 12. It can be seen that Group2 is not operating because the proportions of “user” and “system” are low.

In the above embodiments of the present invention, the operation of each node is converted into numerical values based on system information, CPU information, profiling information, etc., and the numerical values of the nodes are evaluated as features of the node and compared with each other. Therefore, the operation of the nodes can be analyzed quantitatively using various performance indexes.

For example, the performance data classifier 116 statistically processes performance data of nodes which are collected when the nodes are in operation, classifies the nodes into a desired number of groups, and compares the groups for their performance. The information to be reviewed can thus be greatly reduced in quantity for efficient evaluation.

When the nodes that make up the cluster system 200 operate in the same way, then any performance differences between the classified groups should be small. If there is a significant performance difference between the groups, then there should be an abnormally operating node group among the groups. If the operation of each node can be predicted, then the nodes may be classified into a predictable number of groups, and the results of grouping of the nodes may be checked to find a node group which behaves abnormally.

When the machine information (the number of CPUs, a cache size, etc.) of each node, which can be expressed as numerical values, is acquired, and the machine information as well as performance data measured when the nodes are in operation is used to classify the nodes, it is possible to discover a performance difference due to a different machine configuration.

When the cluster performance value calculator 111 analyzes performance data collected from a plurality of cluster systems, the cluster systems can be compared with each other for performance.

According to the present invention, as described above, the cluster system can easily be understood for its behavior and analyzed for its performance, and an abnormally behaving node group can automatically be located.

The processing functions described above can be implemented by a computer. The computer executes a program which is descriptive of the details of the functions to be performed by the management server and the nodes, thereby carrying out the processing functions. The program can be recorded on recording mediums that can be read by the computer. Recording mediums that can be read by the computer include a magnetic recording device, an optical disc, a magneto-optical recording medium, a semiconductor memory, etc. Magnetic recording devices include a hard disk drive (HDD), a flexible disk (FD), a magnetic tape, etc. Optical discs include a DVD (Digital Versatile Disc), a DVD-RAM (Digital Versatile Disc Random-Access Memory), a CD-ROM (Compact Disc Read-Only Memory), a CD-R (Recordable)/RW (ReWritable), etc. Magneto-optical recording mediums include an MO (Magneto-Optical) disk.

For distributing the program, portable recording mediums such as DVDs, CD-ROMs, etc. which store the program are offered for sale. Furthermore, the program may be stored in a memory of the server computer, and then transferred from the server computer to another client computer via a network.

The computer which executes the program stores the program stored in a portable recording medium or transferred from the server computer into its own memory. Then, the computer reads the program from its own memory, and performs processing sequences according to the program. Alternatively, the computer may directly read the program from the portable recording medium and perform processing sequences according to the program. Further alternatively, each time the computer receives a program segment from the server computer, the computer may perform a processing sequence according to the received program segment.

According to the present invention, inasmuch as the nodes are classified into groups depending on their performance data, and the performance values of the groups are displayed for comparison, it is easy for the user to judge which group a problematic node belongs to. As a result, a node that is peculiar in performance in a cluster system, as well as unknown problems, can efficiently be searched for.

The foregoing is considered as illustrative only of the principles of the present invention. Further, since numerous modification and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium storing a performance analyzing program for analyzing performance of a cluster system by enabling said computer to function as:
performance data analyzing means for collecting performance data of nodes which make up said cluster system from performance data storage means for storing a plurality of types of performance data of the nodes, and analyzing performance values of said nodes based on the collected performance data;
classifying means for classifying said nodes into a plurality of groups by statistically processing said performance data collected by said performance data analyzing means according to a predetermined classifying condition;
group performance value calculating means for statistically processing said performance data of the respective groups based on said performance data of said nodes classified into said groups, and calculating statistic values for the respective types of the performance data of said groups; and
performance data comparison display means for displaying the statistic values of the groups for the respective types of the performance data for comparison between the groups.

2. The computer-readable recording medium according to claim 1, wherein said performance data analyzing means collects profiling data representing execution times of functions executed respectively by said nodes as said performance data, and said classifying means classifies the nodes according to the execution times of functions.

3. The computer-readable recording medium according to claim 1, wherein said performance data analyzing means collects data representing executed states of instructions in respective CPUs of said nodes, and said classifying means classifies the nodes according to the executed states of instructions.

4. The computer-readable recording medium according to claim 1, wherein said performance data analyzing means collects said performance data representative of operating states of respective operating systems of said nodes, and said classifying means classifies the nodes according to the operating states of respective operating systems.

5. The computer-readable recording medium according to claim 1, wherein said performance data comparison display means regards the statistic value of any one of said groups as 1 and displays the statistic values of the other groups against said statistic value regarded as 1 for comparison between said groups.

6. The computer-readable recording medium according to claim 1, wherein said performance data comparison display means displays the statistic values of said groups as a bar graph and displays bars representative of a dispersed pattern of the performance data of the nodes belonging to said groups.

7. A method of analyzing performance of a cluster system with a computer, comprising the steps of:
controlling said computer to function as performance data analyzing means for collecting performance data of nodes which make up said cluster system from performance data storage means for storing a plurality of types of performance data of the nodes, and analyzing performance values of said nodes based on the collected performance data;
controlling said computer to function as classifying means for classifying said nodes into a plurality of groups by statistically processing said performance data collected by said performance data analyzing means according to a predetermined classifying condition;
controlling said computer to function as group performance value calculating means for statistically processing said performance data of the respective groups based on said performance data of said nodes classified into said groups, and calculating statistic values for the respective types of the performance data of said groups; and
controlling said computer to function as performance data comparison display means for displaying the statistic values of the groups for the respective types of the performance data for comparison between the groups.

8. The method according to claim 7, wherein said performance data analyzing means collects profiling data representing execution times of functions executed respectively by said nodes as said performance data, and said classifying means classifies the nodes according to the execution times of functions.

9. A performance analyzing apparatus for analyzing performance of a cluster system, comprising:
performance data analyzing means for collecting performance data of nodes which make up said cluster system from performance data storage means for storing a plurality of types of performance data of the nodes, and analyzing performance values of said nodes based on the collected performance data;
classifying means for classifying said nodes into a plurality of groups by statistically processing said performance data collected by said performance data analyzing means according to a predetermined classifying condition;
group performance value calculating means for statistically processing said performance data of the respective groups based on said performance data of said nodes classified into said groups, and calculating statistic values for the respective types of the performance data of said groups; and
performance data comparison display means for displaying the statistic values of the groups for the respective types of the performance data for comparison between the groups.

10. The performance analyzing apparatus according to claim 9, wherein said performance data analyzing means collects profiling data representing execution times of functions executed respectively by said nodes as said performance data, and said classifying means classifies the nodes according to the execution times of functions.
